(19) United States
(12) Patent Application Publication
(10) Pub. No.: US 2026/0019170 A1
(43) Pub. Date: Jan. 15, 2026

(54) OVER-THE-AIR MEASUREMENT SYSTEM AND METHOD

(71) Applicant: Rohde & Schwarz GmbH & Co. KG, Muenchen (DE)

(72) Inventors: Thomas GEMMER, Muenchen (DE); Fabian BETTE, Muenchen (DE)

(21) Appl. No.: 19/210,236

(22) Filed: May 16, 2025

(30) Foreign Application Priority Data
Jul. 11, 2024 (EP) 24 188 022.8

(51) Int. Cl. H04B 17/15; H01Q 15/14; H04B 7/04; H04B 17/00

(52) U.S. Cl. CPC H04B 17/191; H01Q 15/148; H04B 7/04013; H04B 17/0085

(57) ABSTRACT

A system includes a positioner unit configured to hold a passive RF structure in an adaptable position. The system also includes an instrument configured to generate a stimulus RF signal and an RF antenna being connected to the instrument. The RF antenna is configured to transmit the stimulus RF signal to the passive RF structure in a first polarization and/or in a second polarization and to receive a reflected signal from the passive RF structure in the first polarization and/or in the second polarization. The instrument further is configured to obtain measurement data based on the stimulus RF signal and the reflected signal. An analysis circuit determines a corrected equivalent source of the passive RF structure based on a distance between the RF antenna and the passive RF structure and based on the measurement data, wherein the corrected equivalent source is corrected for an influence of the RF antenna.

### CROSS-REFERENCE TO RELATED APPLICATION

This application claims priority to European Application No. 24 188 022.8, fled on Jul. 11, 2024, the entire disclosure of which is enclosed herein in its entirety.

### FILED OF THE DISCLOSURE

Embodiments of the present disclosure generally relate to an over-the-air, OTA, measurement system. Embodiments of the present disclosure further relate to an OTA measurement method.

### BACKGROUND

A reconfigurable intelligent surface (RIS) reflects an impinging RF signal into a certain, configurable direction, thereby allowing to shape the path of travel of the RF signal. In other words, RISs allow for passive beamforming of RF signals.

RISs can be utilized in order to extend the range of wireless communication devices as well as in order to enhance the quality of data links between wireless communication devices by appropriately adapting lobes of the RF signal to a location of the respective wireless device. As a result, RISs may be a key technology for upcoming wireless communication standards, such as 6G.

Like for other devices employed in wireless communication, there is a need to test RISs with respect to their operational properties, such as their beamforming capabilities. For example, RISs or other passive RF structures are tested by a bistatic antenna over-the-air (OTA) measurement system comprising a feed antenna transmitting an RF signal to the RIS, and a probe antenna receiving a reflected signal from the RIS, wherein both antennas are arranged in a far-field region of the RIS. However, the spatial requirements for this type of measurements is rather large.

As another example, passive RF structures may be tested using a compact antenna test range (CATR), wherein the far-field conditions are obtained by a reflector that is provided in the signal path between the RF antenna and the RIS. While reducing the spatial requirements, these methods require additional equipment such as the reflector(s).

Thus, there is a need for an OTA measurement system and an OTA measurement method that are more efficient with respect to manufacturing costs and/or spatial requirements.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

Embodiments of the present disclosure provide an over-the-air (OTA) measurement system for testing a passive radio frequency (RF) structure. In an embodiment, the OTA measurement system comprises a positioner unit that is configured to hold the passive RF structure in an adaptable position, wherein the positioner unit is configured to modify the adaptable position. The OTA measurement system also comprises at least one test and/or measurement instrument, wherein the at least one test and/or measurement instrument is configured to generate a stimulus RF signal. The OTA measurement system further comprises at least one RF antenna being connected to the at least one test and/or measurement instrument, wherein the at least one RF antenna is configured to receive the stimulus RF signal from the test and/or measurement instrument, and to transmit the stimulus RF signal to the passive RF structure in a first polarization and/or in a second polarization. The at least one RF antenna is further configured to receive a reflected signal from the passive RF structure in the first polarization and/or in the second polarization, and to transmit the received reflected signal to the test and/or measurement instrument. The at least one test and/or measurement instrument is further configured to obtain measurement data based on the stimulus RF signal and the reflected signal. The OTA measurement system comprises an analysis circuit, wherein the analysis circuit is configured to determine a corrected equivalent source of the passive RF structure based on a distance between the at least one RF antenna and the passive RF structure and based on the measurement data, wherein the corrected equivalent source is corrected for an influence of the at least one RF antenna.

In an embodiment, the passive RF structure comprises at least one passive RF circuit, i.e. at least one RF circuit that does not generate electromagnetic waves by itself, and that is configured to reflect impinging electromagnetic waves in a certain defined manner. In an embodiment, the passive RF structure may comprise capacitors, inductances, and/or resistors that may be reconfigurable.

In an embodiment, the passive RF structure may comprise or be connected to a control circuit that is configured to adapt capacitances, inductances, and/or resistances of individual portions (such as unit cells) of the passive RF structure, such that reflectivity properties of the passive RF structure are modified.

As used herein, the term “position” is understood to denote a location, e.g. a x, y, and z coordinate, and an orientation, e.g. in terms of Euler angles.

As used herein, the term “equivalent source” is understood to denote a mathematical model of the respective object, for example of the passive RF structure, that is based on a physical replacement model of the respective object and that has the same electromagnetic properties as the object, for example as the passive RF structure.

For example, the equivalent source may be or comprise equivalent currents, for example equivalent surface currents, and/or a spherical mode expansion of a transmission, receiving, and/or reflectivity pattern of the respective object. In an embodiment, the expansion may be in terms of spherical harmonics.

The equivalent currents and/or the spherical mode expansion may be defined on a minimal surface surrounding the respective object, for example on a minimal sphere.

The OTA measurement system according to embodiments of the present disclosure is based on the idea to determine an equivalent source of the passive RF structure, and to correct the determined equivalent source for the influence of the at least one RF antenna on the measurements conducted.

In an embodiment, the determined equivalent source(s) may be corrected for a known transmission and/or receiving pattern of the at least one RF antenna.

This allows to perform the measurements with the at least one RF antenna, i.e. transmitting the stimulus RF signal to the passive RF structure and receiving the corresponding reflected signal(s), with the at least one RF antenna being positioned in the near-field of the passive RF structure, for example in a radiating near-field region.

In other words, the adaptable position may be such that the passive RF structure is in a near-field region, for example in a radiating near-field region, of the at least one RF antenna. Likewise, the at least one RF antenna may be in a near-field region, for example in a radiating near-field region, of the passive RF structure.

Accordingly, the spatial requirements for performing the OTA measurements are reduced significantly compared to far-field methods, for example compared to direct far-field methods. Moreover, no further components such as reflectors are necessary for performing the measurement, thereby reducing manufacturing costs for the OTA measurement system compared to indirect far-field methods.

Further, placing the at least one RF antenna in the near-field region of the passive RF structure leads to a dynamic range improvement, for example at high frequencies. The reduced distance between the at least one RF antenna and the passive RF structure is particularly advantageous at high frequencies, as the path loss per distance increases with increasing frequency.

Moreover, the influence of stray signals that may disturb the measurements is reduced, as the intensity of the primary measurement signals, namely the intensity of the stimulus RF signal at the passive RF structure and the intensity of the reflected signal at the at least one RF antenna is large compared to the intensity of the stray signals due to the small distance between the passive RF structure and the at least one RF antenna.

In an embodiment, determining the corrected equivalent source, e.g. in terms of equivalent currents and/or in terms of a spherical mode expansion, up to a finite order inherently filters out the influence of stray signals, as a reflection pattern of the passive RF structure usually is associated with lower order terms, while the stray signals are usually associated with higher order terms.

According to an aspect of the present disclosure, the positioner unit, for example, may be configured to modify an azimuth and/or an elevation angle of the passive RF structure. However, it is also conceivable that the positioner unit may be configured to modify a location of the passive RF structure.

In an embodiment, the positioner unit may include any arrangement of motorized or non-motorized angular or linear drives, rotation tables, X-Y, Y-Z, X-Z or X-Y-Z tables, etc., in order to carry out its functionality. When motorized, the positioner unit may receive suitable control signals for actuating movement or positioning of the passive RF structure.

In an embodiment, the analysis circuit may be integrated into the at least one test and/or measurement instrument. However, it is also conceivable that the analysis circuit may be provided separately from the at least one test and/or measurement instrument.

In an embodiment, the first polarization and the second polarization may be linear polarizations.

In an embodiment, the first polarization may be associated with the first polarization plane and the second polarization may be associated with a second polarization plan, wherein the first polarization plane and the second polarization plane enclose a predefined angle, for example 90°.

As another example, the first polarization and the second polarization may be circular polarizations. For example, one of the first polarization and second polarization may be a left-circular polarization, while the other one of the first polarization and the second polarization may be a right-circular polarization.

In an embodiment, obtaining the measurement data may comprise determining the phase and an amplitude of the stimulus RF signal, as well as determining a phase and an amplitude of the reflected signal.

According to an aspect of the present disclosure, the at least one test and/or measurement instrument, for example, at least comprises a vector network analyzer. In other words, the at least one test and/or measurement instrument may be or comprise a vector network analyzer. However, it is to be understood that any other suitable type of test and/or measurement instrument may be used.

In an embodiment, the passive RF structure is or comprises a reconfigurable intelligent surface (RIS). As another example, the passive RF structure may be or comprise an electromagnetic metasurface.

Another aspect of the present disclosure provides that the at least one RF antenna comprises, for example, exactly one RF antenna, wherein the RF antenna is configured to transmit the stimulus RF signal and to receive the reflected signal. Accordingly, the OTA measurements may be performed by the exactly one RF antenna, which may be placed in a near-field region of the passive RF structure. This way, a particularly compact and cost-efficient OTA measurement system is provided.

In another embodiment, the RF antenna is configured to transmit the stimulus RF signal only with the first polarization or with the second polarization, wherein the OTA measurement system comprises an antenna positioner unit that is configured to rotate the RF antenna by a predetermined angle. Accordingly, the RF antenna may be a single-polarization antenna. The first polarization and the second polarization of the stimulus RF signal transmitted to the passive RF structure may be obtained by appropriately rotating the RF antenna to the appropriate orientations by the antenna positioner unit.

In an embodiment, the antenna positioner unit may include any arrangement of one or more motorized or non-motorized angular or linear drives, rotation tables, X-Y, Y-Z, X-Z or X-Y-Z tables, etc., in order to carry out its functionality. When motorized, the antenna positioner unit may receive suitable control signals for actuating movement or positioning of the RF antenna.

In an embodiment, the predetermined angle may correspond to the angle between the first polarization plane and the second polarization plan described above.

In an embodiment, the antenna positioner unit may further be configured to adapt a location of the RF antenna. In other words, the antenna positioner unit may be configured to adapt a relative location of the RF antenna and the passive RF structure.

For example, the antenna positioner unit may be configured to move the RF antenna on a sphere or another suitable surface around the passive RF structure, such that a relative location and/or orientation of the RF antenna and of the passive RF structure is modified. In this case, it may be sufficient for the positioner unit to be configured to adapt the elevation angle or the azimuth angle of the RF antenna.

In an embodiment, the RF antenna is a dual-polarized RF antenna being configured to transmit the stimulus RF signal with the first polarization and with the second polarization. Accordingly, the single RF antenna may be configured to generate both polarizations being necessary for performing the OTA measurements on the passive RF structure.

While the antenna positioner unit described above may still be provided, it is thus not necessary for the antenna positioner unit to be configured to rotate the RF antenna. However, the antenna positioner unit may still be configured to adapt a location of the RF antenna as described above.

In another embodiment, the RF antenna is configured to transmit the stimulus RF signal with the first polarization and with the second polarization simultaneously or consecutively. In other words, the OTA measurements associated with the first polarization and with the second polarization of the stimulus RF signal may be performed simultaneously or consecutively.

According to an aspect of the present disclosure, the RF antenna comprises, for example, a first antenna port and a second antenna port, wherein the test and/or measurement instrument comprises a first instrument port and a second instrument port, wherein the first instrument port is connected with the first antenna port, wherein the second instrument port is connected with the second antenna port, and wherein the test and/or measurement instrument is configured to transmit the same stimulus RF signal to the first antenna port and to the second antenna port. Thus, the OTA measurements associated with the first polarization and with the second polarization of the stimulus RF signal may be performed simultaneously or consecutively, wherein both types of OTA measurements are performed with the same stimulus RF signal being transmitted to the passive RF structure, albeit with different polarization.

However, it is also conceivable that the test and/or measurement instrument may be configured to transmit different stimulus RF signals to the first antenna port and to the second antenna port. For example, the different stimulus RF signals may differ in amplitude and/or phase from each other.

A further aspect of the present disclosure provides that the RF antenna is configured, for example, to forward the reflected signal having the first polarization to the first instrument port, wherein the RF antenna is configured to forward the reflected signal having the second polarization to the second instrument port. Accordingly, the different reflected signals having different polarizations may be forwarded and processed by different instrument ports of the test and/or measurement instrument. This way, the reflected signals may be received and processed simultaneously or consecutively.

In an embodiment, the OTA measurement system may further comprise a switching circuit. The switching circuit has a first port, a second port, and a common port. The RF antenna comprises a first antenna port and a second antenna port. The common port is connected to the test and/or measurement instrument, wherein the first port is connected to the first antenna port, wherein the second port is connected to the second antenna port. The switching circuit is configured to selectively forward the stimulus RF signal to the first antenna port or to the second antenna port. Accordingly, the OTA measurements associated with the first polarization and the second polarization may be performed consecutively, namely by consecutively forwarding the stimulus RF signal to the first antenna port and to the second antenna port by the switching circuit.

In an embodiment, the switching circuit may have a first switch mode, wherein in the first switch mode the stimulus RF signal is forwarded to the first antenna port, and the reflected signal having the first polarization is forwarded to the test and/or measurement instrument. The switching circuit may have a second switch mode, wherein in the second switch mode the stimulus RF signal is forwarded to the second antenna port, and the reflected signal having the second polarization is forwarded to the test and/or measurement instrument.

According to an aspect of the present disclosure, the at least one RF antenna comprises, for example, a first RF antenna and a second RF antenna. The first RF antenna is configured to transmit the stimulus RF signal with the first polarization and/or with the second polarization. Alternatively or additionally, the first RF antenna is configured to receive the reflected signal with the first polarization and/or with the second polarization. Further, the second RF antenna is configured to receive the stimulus RF signal with the first polarization and/or with the second polarization. Alternatively or additionally, the second RF antenna is configured to transmit the reflected signal with the first polarization and/or with the second polarization.

Accordingly, the OTA measurements associated with the different polarizations are performed by the different RF antennas.

In an embodiment, the first RF antenna performs the OTA measurement associated with the first polarization, while the second RF antenna performs the OTA measurement associated with the second polarization.

In another embodiment, the first RF antenna may be configured as feed antenna transmitting the stimulus signal, while the second RF antenna may be configured as probe antenna receiving the reflected signal, or vice versa

In an embodiment, the first RF antenna and the second RF antenna are physically distinct RF antennas that are provided separately from each other.

In an embodiment, the first RF antenna and the second RF antenna may each be placed in a near-field region, for example in a radiating near-field region of the passive RF structure.

It is noted that the OTA measurement system may comprise a plurality of feed antennas and/or a plurality of probe antennas. The measurements described above and hereinafter may likewise be performed by the additional probe and/or feed antennas, but at two or more spatial points simultaneously. This way, the necessary measurement time can be reduced, but at the cost of enhanced complexity.

A further aspect of the present disclosure provides that the test and/or measurement instrument comprises, for example, a first instrument port and a second instrument port, wherein the first instrument port is connected with the first RF antenna and the second instrument port is connected with the second RF antenna. In an embodiment, the test and/or measurement instrument is configured to transmit the same stimulus RF signal to the first RF antenna and to the second RF antenna. Accordingly, the reflected signal having the first polarization may be received by the first RF antenna and may be forwarded to the first instrument port, while the reflected signal having the second polarization may be received by the second RF antenna and may be forwarded to the second instrument port.

Thus, the OTA measurements associated with the first polarization with the second polarization of the stimulus RF signal may be performed simultaneously or consecutively by the first RF antenna and the second RF antenna, respectively. Both types of OTA measurements may be performed with the same stimulus RF signal being transmitted to the passive RF structure, albeit with different polarization.

However, it is also conceivable that the test and/or measurement instrument may be configured to transmit different stimulus RF signals to the first RF antenna and to the second RF antenna. For example, the different stimulus RF signals may differ in amplitude and/or phase from each other.

In an embodiment, the OTA measurement system may further comprise a switching circuit. The switching circuit has a first port, a second port, and a common port. The common port is connected to the test and/or measurement instrument, the first port is connected to the first RF antenna, and the second port is connected to the second RF antenna. The switching circuit is configured to selectively forward the stimulus RF signal to the first RF antenna or to the second RF antenna. Accordingly, the OTA measurements associated with the first polarization and the second polarization may be performed consecutively, namely by consecutively forwarding the stimulus RF signal to the first RF antenna and to the second RF antenna by the switching circuit.

In an embodiment, the switching circuit may have a first switch mode, wherein in the first switch mode the stimulus RF signal is forwarded to the first RF antenna, and the reflected signal having the first polarization is forwarded to the test and/or measurement instrument. The switching circuit may have a second switch mode, wherein in the second switch mode the stimulus RF signal is forwarded to the second RF antenna, and the reflected signal having the second polarization is forwarded to the test and/or measurement instrument.

In an embodiment, the analysis circuit is configured to determine the corrected equivalent source based on an antenna pattern of the at least one RF antenna. In other words, the analysis circuit may be configured to correct the equivalent source determined for the influence of the at least one RF antenna based on the antenna pattern of the at least one RF antenna.

Therein, the “antenna pattern” may refer to a transmission pattern and/or a receiving pattern of the at least one RF antenna.

In an embodiment, the antenna pattern may be known. For example, the antenna pattern may be determined in a calibration measurement of the at least one RF antenna.

In another embodiment of the present disclosure, the test and/or measurement instrument is configured to sweep the stimulus RF signal over a predetermined frequency range.

In an embodiment, the stimulus RF signal generated by the at least one test and/or measurement instrument may be a continuous wave, CW, signal or a modulated signal. A frequency of the CW signal or of a carrier signal of the modulated signal may correspond to an operating frequency of the passive RF structure. Accordingly, the passive RF structure may be tested with a frequency of the at stimulus RF signal corresponding to the operating frequency of the passive RF structure.

Therein and hereinafter, the term “operating frequency of the passive RF structure” is understood to denote a central frequency for which the respective passive RF structure is configured. Typically, passive RF structures have a rather narrow frequency bandwidth of operation around the operating frequency.

In an embodiment, the frequency of the stimulus RF signal generated may be equal to the operating frequency of the passive RF structure or may be within a certain frequency bandwidth around the operating frequency.

In an embodiment, the test and/or measurement instrument may be configured to sweep the stimulus RF signal over a certain frequency bandwidth around the operating frequency, for example such that the relevant operating bandwidth of the passive RF structure is covered.

For example, a frequency of the CW signal or of the carrier signal may be between 1 GHz and 10 THz. However, it is to be understood that the passive RF structure may have an arbitrary operating frequency, i.e. also below 1 GHz or above 10 GHz. Accordingly, the frequency of the CW signal or of the carrier signal may be below 1 GHz or above 10 THz.

In an embodiment, the analysis circuit may be configured to determine a reflection pattern of the passive RF structure based on the corrected equivalent source determined. In other words, the reflection pattern of the passive RF structure may be calculated based on the corrected equivalent source determined rather than being directly measured.

In an embodiment, the reflection pattern determined may comprise a near-field reflection pattern and/or a far-field reflection pattern. Thus, all relevant reflection properties of the passive RF structure can be determined with reduced spatial requirements and in a cost-efficient manner with the OTA measurement system according to the present disclosure.

In other words, based on the corrected equivalent source determined, the reflection pattern of the passive RF structure can be calculated at an arbitrary location or at arbitrary locations.

Embodiments of the present disclosure further provide an OTA measurement method of performing OTA measurements by an OTA measurement system. In an embodiment, the OTA measurement method comprises setting, by a positioner unit, a relative position of a passive RF structure and at least one RF antenna; generating, by at least one test and/or measurement instrument, a stimulus RF signal; transmitting, by the at least one RF antenna, the stimulus RF signal to the passive RF structure in a first polarization and/or in a second polarization; receiving, by the at least one RF antenna, a reflected signal from the passive RF structure in the first polarization and/or in the second polarization; obtaining, by the at least one test and/or measurement instrument, measurement data based on the stimulus RF signal and the reflected signal, and determining, by an analysis circuit, a corrected equivalent source of the passive RF structure based on a distance between the at least one RF antenna and the passive RF structure and based on the measurement data, wherein the corrected equivalent source is corrected for an influence of the at least one RF antenna.

In an embodiment, the OTA measurement system according to any one of the embodiments described above may be configured to perform the OTA measurement method.

Likewise, the OTA measurement method may be performed using the OTA measurement system according to any one of the embodiments described above.

Regarding the advantages and further properties of the OTA measurement method, reference is made to the explanations given above with respect to the OTA measurement system, which also hold for the OTA measurement method and vice versa.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows a first embodiment of an OTA measurement system according to the present disclosure;

FIG. 2 schematically shows a signal processing circuit of an OTA measurement system according to an embodiment of the present disclosure;

FIG. 3 schematically shows a second embodiment of an OTA measurement system according to the present disclosure;

FIG. 4 schematically shows a third embodiment of an OTA measurement system according to the present disclosure;

FIG. 5 schematically shows a fourth embodiment of an OTA measurement system according to the present disclosure;

FIG. 6 schematically shows a fifth embodiment of an OTA measurement system according to the present disclosure;

FIG. 7 shows an example of a flow chart of an OTA measurement method according to an embodiment of the present disclosure; and

FIG. 8 shows a diagram illustrating a step of the OTA measurement method of FIG. 7.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

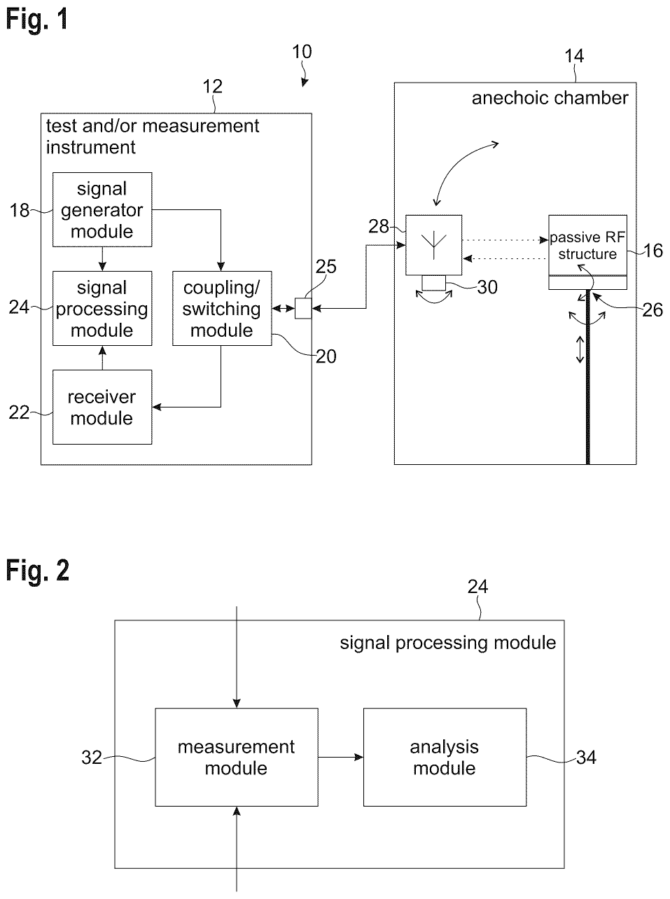

FIG. 1 schematically shows an example of an OTA measurement system 10 comprising a test and/or measurement instrument 12 and an anechoic chamber 14. In general, the OTA measurement system 10 is configured to conduct OTA measurements on a device under test, and more specifically on a passive RF structure 16.

The passive RF structure 16 may, for example, be or comprise a reconfigurable intelligent surface (RIS). As another example, the passive RF structure 16 may be or comprise an electromagnetic metasurface.

In an embodiment, the test and/or measurement instrument 12 may be a vector network analyzer. As another example, the test and/or measurement instrument 12 may be a network analyzer or a spectrum analyzer. However, it is to be understood that any other suitable type of test and/or measurement instrument may be used.

In the embodiment of FIG. 1, the measurement instrument 12 comprises a signal generator circuit 18 that is configured to generate a stimulus RF signal. For example, the stimulus RF signal generated by the signal generator circuit 18 may be a continuous wave signal having a frequency that corresponds to an operating frequency of the passive RF structure 16. As another example, the stimulus RF signal generated by the signal generator circuit 18 may be a modulated signal having a carrier frequency that corresponds to the operating frequency of the passive RF structure 16. In an embodiment, the signal generator circuit may be configured to sweep the stimulus RF signal over a predetermined frequency range around the operating frequency of the passive RF structure 16.

Optionally, the test and/or measurement instrument 12 further comprises a coupling and/or switching circuit 20 that is connected to the signal generator circuit 18 so as to receive the stimulus RF signal generated by the signal generator circuit 18.

The test and/or measurement instrument 12 further comprises a receiver circuit 22 that is connected to the coupling and/or switching circuit 20. Moreover, the test and/or measurement instrument 12 comprises a signal processing circuit 24 that is connected to both the signal generator circuit 18 and the receiver circuit 22. The test and/or measurement instrument 12 further comprises an instrument port 25 that is connected to the coupling and/or switching circuit 20.

In general, the anechoic chamber 14 provides a distortion-free or at least a distortion-reduced environment for testing the passive RF structure 16. In an embodiment, the anechoic chamber 14 may comprise a housing that is configured to shield an interior of the anechoic chamber 14 from external electromagnetic waves. Further, absorber elements may be provided in the interior of the anechoic chamber 14 that reduce unwanted reflections within the anechoic chamber 14.

For testing, the passive RF structure 16 is placed in a positioner unit 26 that is located within the anechoic chamber 14. In general, the positioner unit 26 is configured to hold the passive RF structure 16 in an adaptable position that is suitable for testing the passive RF structure 16. In an embodiment, the positioner unit 26 is configured to modify the adaptable position.

In the example embodiment shown in FIG. 1, the positioner unit 26 is configured to modify an azimuth angle, an elevation angle, and a height of the passive RF structure 16. However, it is to be understood that any other degrees of freedom of the adaptable position of the passive RF structure 16 may be modified by the positioner unit 26 additionally or instead.

In an embodiment, the positioner unit 26 may include any arrangement of motorized or non-motorized angular or linear drives, rotation tables, X-Y, Y-Z, X-Z or X-Y-Z tables, etc., in order to carry out its functionality. When motorized, the positioner unit may receive suitable control signals for actuating movement or positioning of the passive RF structure.

The OTA measurement system 10 further comprises at least one RF antenna 28 that is provided in the anechoic chamber 14. In the embodiment shown in FIG. 1, the at least one RF antenna 28 is a single RF antenna. In general, the RF antenna 28 is configured to transmit the stimulus RF signal generated by the signal generator circuit 18 to the passive RF structure 16, and to receive a corresponding reflected signal from the passive RF structure 16. In a certain embodiment show in FIG. 1, the RF antenna 28 may be a single-polarization antenna, for example a linearly polarized antenna, that is configured to transmit the stimulus RF signal with a predefined polarization, and that is configured to receive the reflected signal with the predefined polarization.

In an embodiment, the RF antenna 28 is coupled to the signal generator circuit 18 via the coupling and/or switching circuit 20 and via the instrument port 25, which forward the stimulus RF signal generated by the signal generator circuit 18 to the RF antenna 28. Further, the RF antenna 28 is connected to the receiver circuit 22 via the instrument port 25 and via the coupling and/or switching circuit 20, which forward the reflected signal received by the RF antenna 28 to the receiver circuit 22.

The OTA measurement system 10 further comprises an antenna positioner unit 30 that is configured to rotate the RF antenna 28 by a predetermined angle, for example 90°. The antenna positioner unit 30 may further be configured to adapt a location of the RF antenna 28. For example, the antenna positioner unit 30 may be configured to move the RF antenna 28 on a sphere or another suitable surface around the passive RF structure 16, such that a relative location and/or a relative orientation of the RF antenna 28 and of the passive RF structure 16 are/is modified.

In an embodiment, the antenna positioner unit 30 may include any arrangement of motorized or non-motorized angular or linear drives, rotation tables, X-Y, Y-Z, X-Z or X-Y-Z tables, etc., in order to carry out its functionality. When motorized, the antenna positioner unit may receive suitable control signals for actuating movement or positioning of the RF antenna 28.

As described above, the positioner unit 26 is configured to hold the passive RF structure 16 in the adaptable position. Therein, the adaptable position is chosen such that near-field conditions of the transmitted stimulus RF signal are obtained at the passive RF structure 16, and such that near-field conditions of the reflected signal are obtained at the RF antenna 28. Accordingly, the OTA measurement system 10 is established as a near-field OTA measurement system.

FIG. 2 shows an example of the signal processing circuit 24 in more detail. The signal processing circuit 24 comprises a measurement circuit 32 that is connected to the signal generator circuit 18 and to the receiver circuit 22, so as to receive the stimulus RF signal and the reflected signal, respectively. The signal processing circuit 24 further comprises an analysis circuit 34 that is connected to the measurement circuit 32 downstream of the measurement circuit 32.

It is noted that while the analysis circuit 34 is shown to be integrated into the test and/or measurement instrument 12 in FIGS. 1 and 2, it is also conceivable that the analysis circuit 34 may be provided separately from the test and/or measurement instrument 12, e.g. in a further test and/or measurement instrument or in an external computer device such as a personal computer, a laptop, a notebook, a server, or another suitable type of smart device.

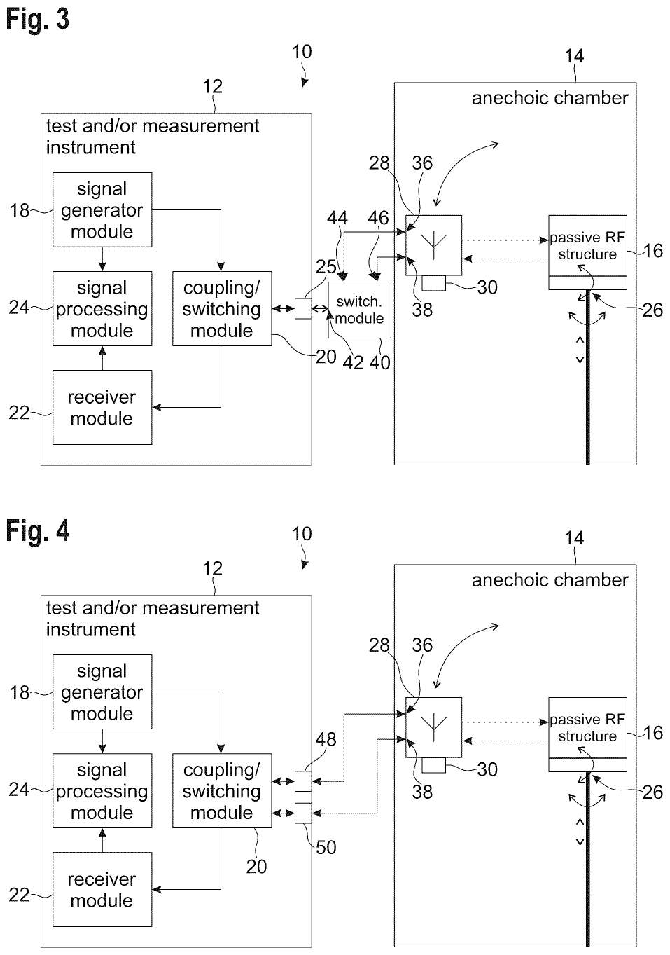

FIG. 3 shows another embodiment of the OTA measurement system 10, wherein only the differences compared to the first embodiment described above with reference to FIG. 1 are explained hereinafter. In this embodiment, the RF antenna 28 may be a dual-polarized RF antenna, i.e. the RF antenna 28 is configured to transmit the stimulus RF signal with two different polarizations simultaneously or consecutively.

In an embodiment, the RF antenna 28 comprises a first antenna port 36 and a second antenna port 38 that are each configured to receive the stimulus signal. The RF antenna 28 is configured to transmit the stimulus signal received via the first antenna port 36 with a first polarization, and to transmit the stimulus signal received via the second antenna port 38 with a second polarization.

In the embodiment shown in FIG. 3, the OTA measurement system 10 further comprises a switching circuit 40. The switching circuit 40 comprises a common port 42 that is connected to the instrument port 25. The switching circuit 40 further comprises a first port 44 that is connected to the first antenna port 36, as well as a second port 46 that is connected to the second antenna port 38. In general, the switching circuit 40 is configured to selectively forward the stimulus RF signal from the test and/or measurement instrument 12 to the first antenna port 36 or to the second antenna port 38.

In the embodiment shown in FIG. 3, it is not necessary (but still possible) that the antenna positioner unit 30 is configured to rotate the RF antenna 28 by the predetermined angle. The antenna positioner unit 30 may be configured to adapt a location of the RF antenna 28 as described above.

FIG. 4 shows another embodiment of the OTA measurement system 10, wherein only the differences compared to the embodiment described above with reference to FIG. 3 are explained hereinafter. In this embodiment, the test and/or measurement instrument 12 comprises a first instrument port 48 and a second instrument port 50.

The first instrument port 48 and the second instrument port 50 are each connected to the coupling and/or switching circuit 20. The first instrument port 48 is connected to the first antenna port 36, while the second instrument port 50 is connected to the second antenna port 38.

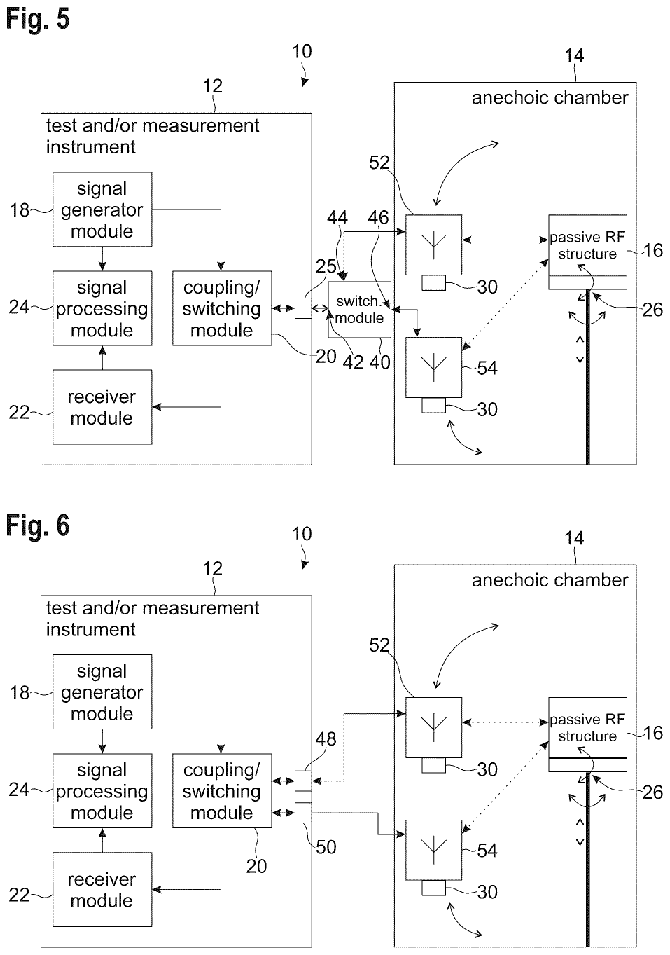

FIG. 5 shows another embodiment of the OTA measurement system 10, wherein only the differences compared to the embodiment described above with reference to FIG. 3 are explained hereinafter. In this embodiment, the OTA measurement system 10 comprises a first RF antenna 52 and a second RF antenna 54.

The first RF antenna 52 is connected to the first port 44 of the switching circuit 40. The second RF antenna 54 is connected to the second port 46 of the switching circuit 40. Therein, the first RF antenna 52 may be a single-polarization RF antenna or a dual-polarization antenna.

The first RF antenna 52 may be configured as a feed antenna and/or as a probe antenna, as will be described in more detail below. Likewise, the second RF antenna 54 may be a single-polarization RF antenna or a dual-polarization antenna. The second RF antenna 54 may be configured as a feed antenna and/or as a probe antenna.

The antenna positioner unit 30 may be configured to rotate the first RF antenna 52 and/or the second RF antenna 54. Alternatively or additionally, the antenna positioner unit 30 may be configured to adapt a location of the first RF antenna 52, and/or a location of the second RF antenna 54.

FIG. 6 shows another embodiment of the OTA measurement system 10, wherein only the differences compared to the embodiment described above with reference to FIG. 4 are explained hereinafter. In this embodiment, the OTA measurement system 10 comprises a first RF antenna 52 and a second RF antenna 54.

The first RF antenna 52 is connected to the first instrument port 48. The second RF antenna 54 is connected to the second instrument port 50. Therein, the first RF antenna 52 may be a single-polarization RF antenna or a dual-polarization antenna. Likewise, the second RF antenna 54 may be a single-polarization RF antenna or a dual-polarization antenna.

The first RF antenna 52 may be configured as a feed antenna and/or as a probe antenna, as will be described in more detail below. The second RF antenna 54 may be configured as a feed antenna and/or as a probe antenna.

The antenna positioner unit 30 may be configured to rotate the first RF antenna 52 and/or the second RF antenna 54. Alternatively or additionally, the antenna positioner unit 30 may be configured to adapt a location of the first RF antenna 52, and/or a location of the second RF antenna 54.

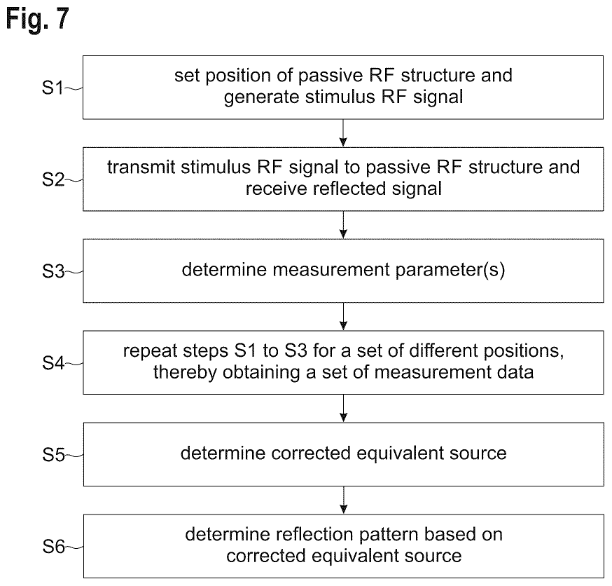

The OTA measurement system 10 according to any one of the embodiments described above is configured to perform an OTA measurement method, an example of which is described hereinafter with reference to FIG. 7.

Hereinafter, the term “relative position” refers to a position of the passive RF structure 16 relative to the RF antenna(s) described above.

A relative position of the passive RF structure 16 is set by the positioner unit 26 and/or by the antenna positioner unit 30, and a stimulus RF signal is generated by the signal generator circuit 18 (step S1).

The stimulus RF signal is transmitted to the passive RF structure 16 with a first polarization and with a second polarization, and a corresponding reflected signal that is reflected by the passive RF structure 16 is received with a first polarization and with a second polarization (step S2).

In the embodiment of FIG. 1, with the RF antenna 28 being a single-polarization antenna, the stimulus signal may first be transmitted with the first polarization by the RF antenna 28 and the corresponding reflected signal is received by the RF antenna 28 with the first polarization.

Afterwards, the RF antenna 28 may be rotated by the predetermined angle by the antenna positioner unit 30. The stimulus signal may then be transmitted with the second polarization by the RF antenna 28 and the corresponding reflected signal is received by the RF antenna 28 with the second polarization.

In the embodiment of FIG. 3, with the RF antenna 28 being a dual-polarization antenna, the stimulus signal may be transmitted with the first polarization and with the second polarization consecutively.

In an embodiment, the switching circuit 40 may have a first switch mode, wherein in the first switch mode the stimulus RF signal is forwarded to the first antenna port 36, wherein the stimulus RF signal having the first polarization is transmitted and the reflected signal having the first polarization is received by the RF antenna 28.

The switching circuit 40 may have a second switch mode, wherein in the second switch mode the stimulus RF signal is forwarded to the second antenna port 38, wherein the stimulus RF signal having the second polarization is transmitted and the reflected signal having the second polarization is received by the RF antenna 28.

Therein, the same stimulus signal may be generated and forwarded to the first antenna port 36 and the second antenna port 38. However, it is also conceivable that different stimulus signals may be generated and forwarded to the first antenna port 36 and the second antenna port 38. For example, the different stimulus signals may have different amplitudes and/or phases.

In the embodiment of FIG. 4, with the RF antenna 28 being a dual-polarization antenna, the stimulus signal may be transmitted with the first polarization and with the second polarization simultaneously or consecutively.

In an embodiment, the stimulus RF signal may be forwarded to the first antenna port 36 via the coupling and/or switching circuit 20 and the first instrument port 48, while the same or a different stimulus RF signal may be forwarded to the second antenna port 38 via the coupling and/or switching circuit 20 and the second instrument port 50. The stimulus RF signal may be forwarded to the first antenna port 36 and to the second antenna port simultaneously or consecutively.

Referring to the embodiment of the OTA measurement system 10 shown in FIG. 5, there are a plurality of possible embodiments of performing step S2.

According to a first embodiment, the RF antennas 52, 54 may each be a single-polarization antenna, and each RF antenna 52, 54 may be configured as both feed antenna and probe antenna. In this embodiment, in a first switch mode of the switching circuit 40, the stimulus RF signal may be forwarded to the first RF antenna 52 by the switching circuit 40. The first RF antenna 52 may transmit the stimulus signal with the first polarization and may receive the corresponding reflected signal with the first polarization.

Afterwards, in a second switching mode of the switching circuit 40, the same or a different stimulus RF signal may be forwarded to the second RF antenna 54 by the switching circuit 40. The second RF antenna 54 may transmit the stimulus signal with the second polarization and may receive the corresponding reflected signal with the second polarization.

According to a second embodiment, the RF antennas 52, 54 may each be a single-polarization antenna, wherein the first RF antenna 52 is configured as feed antenna and the second RF antenna 54 is configured as probe antenna. Accordingly, the stimulus RF signal may be forwarded to the first RF antenna 52 by the coupling and/or switching circuit 20 and the switching circuit 40.

The stimulus RF signal having the first polarization is transmitted by the first RF antenna 52, and the corresponding reflected signal having the first polarization is received by the second RF antenna 54. Afterwards, the first RF antenna 52 and the second RF antenna 54 may be rotated by the antenna positional unit 30 by the predefined angle, respectively. The stimulus RF signal having the second polarization is then transmitted by the first RF antenna 52, and the corresponding reflected signal having the second polarization is received by the second RF antenna 54. The reflected signal received by the second RF antenna 54 may be forwarded to the test and/or measurement instrument 12 by the switching circuit 40.

It is also conceivable that step S2 as described above is performed for a first switch mode of the switching circuit 40, and that the switching circuit 40 may have a second switch mode for which the second RF antenna 54 is configured as feed antenna, while the first RF antenna 52 is configured as probe antenna.

According to a third embodiment, the RF antennas 52, 54 may each be a dual-polarization antenna, wherein the first RF antenna 52 is configured as feed antenna and the second RF antenna 54 is configured as probe antenna.

Therein, the first RF antenna 52 may transmit the stimulus RF signal having the first polarization and the second polarization simultaneously or consecutively.

Accordingly, the reflected signal having the first polarization and the reflected signal having the second polarization may be received by the second RF antenna 54 simultaneously or consecutively.

It is noted that combinations of the embodiments described above, for example combinations of a single-polarization RF antenna and a dual-polarization antenna, are also possible.

Referring to the embodiment of the OTA measurement system 10 shown in FIG. 6, the plurality of possibilities described above with respect to FIG. 5 likewise apply, wherein the test and/or measurement instrument 12 is configured to forward the stimulus signal to the respective RF antenna(s) simultaneously or consecutively.

Irrespective of the embodiment, the reflection signal having the first polarization and the reflection signal having the second polarization are forwarded to the test and/or measurement instrument 12, for example to the receiver circuit 22. The receiver circuit 22 processes the reflected signals appropriately and forwards the reflected signals to the signal processing circuit 24. For example, the receiver circuit 22 may be configured to down-convert the reflected signals in frequency, filter the reflected signals, and/or digitize the reflected signals.

At least one measurement parameter is obtained by the signal processing circuit 24, or more precisely by the measurement circuit 32 based on the reflected signal having the first polarization, based on the reflected signal having the second polarization, and based on the stimulus RF signal (step S3).

Therein, the measurement circuit 32 may determine an amplitude and phase of the stimulus RF signal, an amplitude and a phase of the reflected signal having the first polarization, and an amplitude and a phase of the reflected signal having the second polarization.

Steps S1 to S3 describe above are repeated for a plurality of different relative positions of the passive RF structure 16, thereby obtaining a set of measurement data (step S4).

In an embodiment, the set of measurement data comprises the at least one measurement parameter for each of the different relative positions of the passive RF structure 16. In other words, the positioner unit 26 and/or the antenna positioner unit 30 may modify the relative position to a set of different relative positions consecutively, and the at least one measurement parameter may be determined at the different relative positions, respectively. For example, the azimuth angle and/or the elevation angle of the passive RF structure 16 may be adapted between the different positions.

Therein, the set of different relative positions may be chosen such that at least the complete solid angle range that is relevant for the functionality of the passive RF structure is covered by the set of different relative positions. Further, the set of different relative positions may be chosen such that for each relative position the passive RF structure 16 is in a radiating near-field region of the at least one RF antenna and vice versa.

A corrected equivalent source of the passive RF structure 16 is determined by the analysis circuit 34 based on a known distance between the at least one RF antenna and the passive RF structure 16, and based on the set of measurement data (step S5).

Therein, the distance between the at least one RF antenna and the passive RF structure 16 is, for example, known due to a known respective position of the positioner unit 26 and of the antenna positioner unit 30.

In general, the corrected equivalent source of the passive RF structure 16 corresponds to an equivalent source for the passive RF structure 16 that has been corrected for an influence of the at least one RF antenna, i.e. for the influence of the RF antenna 28 or for the influences of the RF antennas 52, 54. In an embodiment, the analysis circuit 34 may determine the corrected equivalent source based on a known antenna pattern of the at least one RF antenna, i.e. based on a known antenna pattern of the RF antenna 28 or of the RF antennas 52, 54.

In an embodiment, the antenna pattern of the at least one RF antenna for the respective polarization of the stimulus RF signal may be taken into account. In an embodiment, the antenna pattern of the RF antenna 28, of the first RF antenna 52, and/or of the second RF antenna 54 for the different orientations may be taken into account, namely for the case of the at least one RF antenna being a single-polarization antenna that is rotated between measurements. As another example, the antenna pattern of the RF antenna 28, of the first RF antenna 52, and/or of the second RF antenna 54 for the different polarizations may be taken into account, namely for the case of the at least one RF antenna being a dual-polarization antenna.

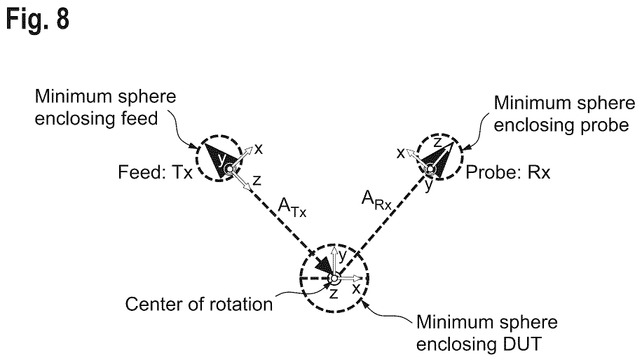

For an exemplary case of a feed antenna and a probe antenna (i.e. for example for the embodiments shown in FIGS. 5 and 6), this is illustrated in FIG. 8.

The feed antenna has a known distance ATₓ from the passive RF structure 16 (“DUT” in FIG. 8). The probe antenna has a known distance A_{Rx} from the passive RF structure 16.

A signal measured by the probe antenna can be described as

$${w}_{r} ( {A}_{Rx} , χ , θ , ϕ ) = \frac{v}{2} {{\sum }_{smn}}_{σμ v} {T}_{smn}^{DUT} {e}^{im ϕ} {d}_{μ m}^{n} ( θ ) {e}^{i μχ} {C}_{σμ v}^{sn ( c )} ( {kA}_{Rx} ) {R}_{σμ v}^{p}$$

Therein, v is the excitation amplitude, T^{DUT} describes the complex transmit spherical mode coefficients of the DUT, i.e. of the passive RF structure 16, R^{p} describes the complex receive spherical mode coefficients of the probe antenna, i.e. the at least one RF antenna receiving the reflected signal, and the remaining factors described the relative orientation, polarization, and position between the probe antenna and the passive RF structure 16.

Further, a signal received by the passive RF structure 16 that is transmitted by the feed antenna can be described as

$${w}_{t} ( {A}_{Tx} , χ , θ , ϕ ) = \frac{v}{2} {{\sum }_{smn}}_{αβγ} {R}_{smn}^{DUT} {e}^{im ϕ} {d}_{β m}^{n} ( θ ) {e}^{i βχ} {C}_{αβγ}^{sn ( c )} ( {kA}_{Tx} ) {T}_{αβγ}^{f}$$

Therein, T^{f} describes the complex transmit spherical mode coefficients of the feed antenna, i.e. the at least one RF antenna transmitting the stimulus RF signal, and R^{DUT} describes the complex receive spherical mode coefficients of the DUT, i.e. of the passive RF structure 16.

The overall measured signal w is then given by a product of wᵣ and wₜ, i.e.

$$w ( {A}_{Tx} , {A}_{Rx} , χ , θ , ϕ ) = {w}_{t} ( {A}_{Tx} , χ , θ , ϕ ) {w}_{r} ( {A}_{Rx} , χ , θ , ϕ )$$

Using symmetry relations, for example reciprocity relations, for the passive RF structure the feed antenna, and/or the probe antenna this can be transformed into

$${w}_{t} ( {A}_{Tx} , {A}_{Rx} , χ , θ , ϕ ) = \frac{v}{2} \{ \begin{matrix}{{{\sum }_{smn}}_{αβγ}}_{σμ v} {( - 1 )}^{m + n} {T}_{\text{?} , - m , n}^{{\text{?}}_{DUT}} {e}^{2 im ϕ} {d}_{β m}^{\text{?}} ( θ ) {e}^{i βχ} {C}_{αβγ}^{\text{?}} ( {kA}_{Tx} ) {( - 1 )}^{β} \\ {R}_{\text{?}}^{f} {d}_{\text{?}}^{\text{?}} ( θ ) {e}^{i μχ} {C}_{σμ v}^{\text{?}} ( {kA}_{Rx} ) {R}_{σμ v}^{\text{?}}\end{matrix} \}$$

$$\text{?} \text{indicates text missing or illegible when filed}$$

This equation for the overall measured signal w can then be solved for the coefficients

$${T}_{s , - m , n}^{2 DUT} ,$$

i.e. for the complex transmit spherical mode coefficients of the passive RF structure 16.

In this case, the complex transmit spherical mode coefficients of the passive RF structure 16 are the corrected equivalent source determined by the analysis circuit 34.

A reflection pattern of the passive RF structure 16 may be determined by the analysis circuit 34 based on the corrected equivalent source determined (step S6).

In an embodiment, the reflection pattern can be calculated based on the corrected equivalent source determined. Therein, the reflection pattern determined may comprise a near-field reflection pattern and/or a far-field reflection pattern.

In general, the reflection pattern of the passive RF structure 16 may be determined for an arbitrary distance from the passive RF structure 16 based on the corrected equivalent source determined. In other words, while the measurements may be performed at a certain distance from the passive RF structure 16, namely in a near-field region, the reflection pattern may be determined or calculated for arbitrary distances based on the corrected equivalent source determined.

In an embodiment, the reflection pattern determined may be a monostatic OTA reflection pattern of the passive RF structure 16 or a bistatic OTA reflection pattern.

The monostatic OTA reflection pattern describes the reflectivity properties of the passive RF structure 16 receiving an RF signal from a source back to the source for a plurality of different relative positions of the passive RF structure 16 and the source, for example for a plurality of different relative orientations. In an embodiment, the monostatic OTA reflection pattern may be determined for the example embodiments of the OTA measurement system 10 shown in FIGS. 1, 3, 4, 5, and/or 6.

The bistatic OTA reflection pattern describes the reflectivity properties of the passive RF structure 16 receiving an RF signal from a source to a sink, namely for a plurality of different relative positions of the passive RF structure 16, the source, and the sink. In an embodiment, the bistatic OTA reflection pattern may be determined for the example embodiments of the OTA measurement system 10 shown in FIGS. 5 and/or 6.

Based on the reflection pattern determined, a performance of the passive RF structure 16 may be assessed, e.g. by comparing the reflection pattern determined with an ideal reflection pattern. In an embodiment, faults of the passive RF structure 16 may be identified based on the reflection pattern determined.

Certain embodiments disclosed herein include systems, apparatus, modules, units, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a graphics processing unit (GPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein.

Of course, in an embodiment, two or more of these components, or parts thereof, can be integrated or share hardware and/or software, circuitry, etc. In an embodiment, these components, or parts thereof, may be grouped in a single location or distributed over a wide area. In circumstances where the components are distributed, the components are accessible to each other via communication links.

In an embodiment, one or more of the components of the measurement system 10 referenced above include circuitry programmed to carry out one or more steps of any of the methods disclosed herein. In an embodiment, one or more computer-readable media associated with or accessible by such circuitry contains computer readable instructions embodied thereon that, when executed by such circuitry, cause the component or circuitry to perform one or more steps of any of the methods disclosed herein.

In an embodiment, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible by a computing device, such as processor circuitry, etc., or other circuitry disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In an embodiment, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

It will be appreciated that in one or more embodiments, the term computer or computing device can include, for example, any computing device or processing structure, including but not limited to a processor (e.g., a microprocessor), a central processing unit (CPU), a digital signal processor (DSP), an application-specific integrated circuit (ASIC), a field-programmable gate array (FPGA), a system on a chip (SoC), a graphics processing unit (GPU) or the like, or any combinations thereof.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

Although the method and various embodiments thereof have been described as performing sequential steps, the claimed subject matter is not intended to be so limited. As nonlimiting examples, the described steps need not be performed in the described sequence and/or not all steps are required to perform the method. Moreover, embodiments are contemplated in which various steps are performed in parallel, in series, and/or a combination thereof. As such, one of ordinary skill will appreciate that such examples are within the scope of the claimed embodiments.

In the detailed description herein, references to “one embodiment”, “an embodiment”, “an example embodiment”, “one or more embodiments”, “some embodiments”, etc., indicate that the embodiment or embodiments described may include a particular feature, structure, or characteristic, but every embodiment may not necessarily include the particular feature, structure, or characteristic. Moreover, such phrases are not necessarily referring to the same embodiment or embodiments. In addition, when a particular feature, structure, or characteristic is described in connection with an embodiment or embodiments, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. While the stated range includes one or both of the limits, ranges excluding either or both of those included limits are also included in the disclosure

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. An over-the-air, OTA, measurement system for testing a passive radio frequency, RF, structure,
wherein the OTA measurement system comprises a positioner unit that is configured to hold the passive RF structure in an adaptable position, wherein the positioner unit is configured to modify the adaptable position,
wherein the OTA measurement system further comprises at least one test and/or measurement instrument, wherein the at least one test and/or measurement instrument is configured to generate a stimulus RF signal,
wherein the OTA measurement system further comprises at least one RF antenna being connected to the at least one test and/or measurement instrument, wherein the at least one RF antenna is configured to receive the stimulus RF signal from the test and/or measurement instrument, and to transmit the stimulus RF signal to the passive RF structure in a first polarization and/or in a second polarization,
wherein the at least one RF antenna is further configured to receive a reflected signal from the passive RF structure in the first polarization and/or in the second polarization, and to transmit the received reflected signal to the test and/or measurement instrument,
wherein the at least one test and/or measurement instrument further is configured to obtain measurement data based on the stimulus RF signal and the reflected signal, and
wherein the OTA measurement system comprises an analysis circuit, wherein the analysis circuit is configured to determine a corrected equivalent source of the passive RF structure based on a distance between the at least one RF antenna and the passive RF structure and based on the measurement data, wherein the corrected equivalent source is corrected for an influence of the at least one RF antenna.

2. The OTA measurement system of claim 1, wherein the passive RF structure is or comprises a reconfigurable intelligent surface, RIS.

3. The OTA measurement system of claim 1, wherein the at least one RF antenna comprises exactly one RF antenna, wherein the RF antenna is configured to transmit the stimulus RF signal and to receive the reflected signal.

4. The OTA measurement system of claim 3, wherein the RF antenna is configured to transmit the stimulus RF signal only with the first polarization or with the second polarization, and wherein the OTA measurement system comprises an antenna positioner unit that is configured to rotate the RF antenna by a predetermined angle.

5. The OTA measurement system of claim 4, wherein the antenna positioner unit further is configured to adapt a location of the RF antenna.

6. The OTA measurement system of claim 3, wherein the RF antenna is a dual-polarized RF antenna being configured to transmit the stimulus RF signal with the first polarization and with the second polarization.

7. The OTA measurement system of claim 6, wherein the RF antenna is configured to transmit the stimulus RF signal with the first polarization and with the second polarization simultaneously or consecutively.

8. The OTA measurement system of claim 6, wherein the RF antenna comprises a first antenna port and a second antenna port, wherein the test and/or measurement instrument comprises a first instrument port and a second instrument port, wherein the first instrument port is connected with the first antenna port, wherein the second instrument port is connected with the second antenna port, and wherein the test and/or measurement instrument is configured to transmit the same stimulus RF signal to the first antenna port and to the second antenna port.

9. The OTA measurement system of claim 8, wherein the RF antenna is configured to forward the reflected signal having the first polarization to the first instrument port, and wherein the RF antenna is configured to forward the reflected signal having the second polarization to the second instrument port.

10. The OTA measurement system of claim 6, further comprising a switching circuit, wherein the switching circuit has a first port, a second port, and a common port, wherein the RF antenna comprises a first antenna port and a second antenna port, wherein the common port is connected to the test and/or measurement instrument, wherein the first port is connected to the first antenna port, wherein the second port is connected to the second antenna port, and wherein the switching circuit is configured to selectively forward the stimulus RF signal to the first antenna port or to the second antenna port.

11. The OTA measurement system of claim 10, wherein the switching circuit has a first switch mode, wherein in the first switch mode the stimulus RF signal is forwarded to the first antenna port, and the reflected signal having the first polarization is forwarded to the test and/or measurement instrument, and
wherein the switching circuit has a second switch mode, wherein in the second switch mode the stimulus RF signal is forwarded to the second antenna port, and the reflected signal having the second polarization is forwarded to the test and/or measurement instrument.

12. The OTA measurement system of claim 1, wherein the at least one RF antenna comprises a first RF antenna and a second RF antenna, wherein the first RF antenna is configured to transmit the stimulus RF signal with the first polarization and/or with the second polarization, and/or wherein the first RF antenna is configured to receive the reflected signal with the first polarization and/or with the second polarization, and
wherein the second RF antenna is configured to receive the stimulus RF signal with the first polarization and/or with the second polarization, and/or wherein the second RF antenna is configured to transmit the reflected signal with the first polarization and/or with the second polarization.

13. The OTA measurement system of claim 12, wherein the test and/or measurement instrument comprises a first instrument port and a second instrument port, wherein the first instrument port is connected with the first RF antenna, wherein the second instrument port is connected with the second RF antenna, and wherein the test and/or measurement instrument is configured to transmit the same stimulus RF signal to the first RF antenna and to the second RF antenna.

14. The OTA measurement system of claim 12, further comprising a switching circuit, wherein the switching circuit has a first port, a second port, and a common port, wherein the common port is connected to the test and/or measurement instrument, wherein the first port is connected to the first RF antenna, wherein the second port is connected to the second RF antenna, and wherein the switching circuit is configured to selectively forward the stimulus RF signal to the first RF antenna or to the second RF antenna.

15. The OTA measurement system of claim 14, wherein the switching circuit has a first switch mode, wherein in the first switch mode the stimulus RF signal is forwarded to the first RF antenna, and the reflected signal having the first polarization is forwarded to the test and/or measurement instrument, and wherein the switching circuit has a second switch mode, wherein in the second switch mode the stimulus RF signal is forwarded to the second RF antenna, and the reflected signal having the second polarization is forwarded to the test and/or measurement instrument.

16. The OTA measurement system according to claim 1, wherein the analysis circuit is configured to determine the corrected equivalent source based on an antenna pattern of the at least one RF antenna.

17. The OTA measurement system according to claim 1, wherein the test and/or measurement instrument is configured to sweep the stimulus RF signal over a predetermined frequency range.

18. The OTA measurement system according to claim 1, wherein the analysis circuit is configured to determine a reflection pattern of the passive RF structure based on the corrected equivalent source determined.

19. The OTA measurement system of claim 18, wherein the reflection pattern determined comprises a near-field reflection pattern and/or a far-field reflection pattern.

20. An OTA measurement method of performing OTA measurements by an OTA measurement system, the OTA measurement method comprising:
setting, by a positioner unit, a relative position of a passive RF structure and at least one RF antenna;
generating, by at least one test and/or measurement instrument, a stimulus RF signal;
transmitting, by the at least one RF antenna, the stimulus RF signal to the passive RF structure in a first polarization and/or in a second polarization;
receiving, by the at least one RF antenna, a reflected signal from the passive RF structure in the first polarization and/or in the second polarization;
obtaining, by the at least one test and/or measurement instrument, measurement data based on the stimulus RF signal and the reflected signal, and
determining, by an analysis circuit, a corrected equivalent source of the passive RF structure based on a distance between the at least one RF antenna and the passive RF structure and based on the measurement data, wherein the corrected equivalent source is corrected for an influence of the at least one RF antenna.
